(19) United States
(12) Patent Application Publication
(10) Pub. No.: US 2025/0356507 A1
(43) Pub. Date: Nov. 20, 2025

(54) TARGET-TRACKING APPARATUS AND TARGET-TRACKING METHOD

(71) Applicant: Mitsubishi Electric Corporation, Tokyo (JP)

(72) Inventors: Tetsutaro YAMADA, Tokyo (JP); Yasunori TSUBAKI, Tokyo (JP); Hiroki KUROSE, Tokyo (JP); Ryoma YATAKA, Tokyo (JP); Toshihiro ITO, Tokyo (JP); Ryuhei TAKAHASHI, Tokyo (JP)

(73) Assignee: Mitsubishi Electric Corporation, Tokyo (JP)

(21) Appl. No.: 19/281,875

(22) Filed: Jul. 28, 2025

Related U.S. Application Data
(63) Continuation of application No. PCT/JP2023/007932, filed on Mar. 3, 2023.

(51) Int. Cl. G06T 7/246; G06T 7/73; G06V 10/44; G06V 10/764; G06V 20/52

(52) U.S. Cl. CPC G06T 7/246; G06T 7/73; G06V 10/44; G06V 10/764; G06V 20/52; G06V 2201/07

(57) ABSTRACT

A target-tracking apparatus including: a detection unit that detects feature amounts from sensor data, the feature amounts including a position of at least one target; a tracking unit that tracks the target on a basis of the detected feature amounts and outputs a track of the target being tracked; and a track classification unit that determines to which of a plurality of predetermined movement patterns the output track corresponds.

### CROSS REFERENCE TO RELATED APPLICATION

This application is a Continuation of PCT International Application No. PCT/JP2023/007932, filed on Mar. 3, 2023, which is hereby expressly incorporated by reference into the present application.

### TECHNICAL FIELD

The present disclosure relates to a target-tracking technique.

### BACKGROUND ART

There is a demand for the monitoring of targets for various purposes such as preventive maintenance or guided advertising. As a means for continuously monitoring a target, there is a technique of detecting a target by using a non-contact sensor, such as a camera, a radar, or a laser, and tracking the detected target. As a target detection and tracking technique, there is a conventional technique as disclosed in the following patent literature. Patent Literature 1 describes a method for detecting a target by using a camera and a method for tracking the detected target.

### CITATION LIST

### Patent Literatures

Patent Literature 1: WO 2021/171498 A

### SUMMARY OF INVENTION

### Technical Problem

According to the conventional technique, the tracking of a target to be observed is performed only on the basis of observation data regarding the target. Therefore, the conventional technique has a problem in that under a multi-target congestion environment where a plurality of targets is present, the targets cannot be separately tracked with accuracy.

The present disclosure has been made so as to solve such a problem, and an object of the present disclosure is to provide a target-tracking technique that enables targets to be separately tracked with accuracy even under a multi-target congestion environment.

### Solution to Problem

One aspect of a target-tracking apparatus according to an embodiment of the present disclosure includes: detection circuitry to detect a feature amount from sensor data, the feature amount including a position of at least one target; tracking circuitry to track the target on the basis of the detected feature amount and output a track of the target being tracked, the track including position information and data information of the track; and track classification circuitry to classify the output track as any one of a plurality of predetermined movement patterns, by using track classification parameters obtained by track classification learning processing on the basis of past data, on the basis of a plurality of elements to consider regarding a way the target is present in a sensing area, indicated by the position information and data information of the track, the elements to consider including at least one of: a position, a velocity, a relationship with another track, or an orientation of the target, and output track information of the classified track.

### Advantageous Effects of Invention

The target-tracking technique according to the embodiment of the present disclosure enables targets to be separately tracked with accuracy even under a multi-target congestion environment.

### BRIEF DESCRIPTION OF DRAWINGS

FIG. 1 is a diagram illustrating an exemplary configuration of a target-tracking apparatus according to a first embodiment.

FIG. 2 is a diagram illustrating an exemplary configuration of a tracking unit according to the first embodiment.

FIG. 3A is a flowchart related to track classification learning processing according to the first embodiment.

FIG. 3B is a flowchart related to track classification inference processing according to the first embodiment.

FIG. 4 is a diagram illustrating an exemplary configuration of a target-tracking apparatus according to a second embodiment.

FIG. 5 is a diagram illustrating an exemplary configuration of a target-tracking apparatus according to a third embodiment.

FIG. 6 is a diagram illustrating an exemplary configuration of a target-tracking apparatus according to a fourth embodiment.

FIG. 7 is a diagram for describing operation of the target-tracking apparatuses according to the first to fourth embodiments.

FIG. 8 is a diagram for describing operation of the target-tracking apparatus according to the third embodiment.

FIG. 9 is a diagram illustrating an exemplary hardware configuration of the target-tracking apparatuses according to the first to fourth embodiments.

FIG. 10 is a diagram illustrating an exemplary hardware configuration of the target-tracking apparatuses according to the first to fourth embodiments.

### DESCRIPTION OF EMBODIMENTS

Hereinafter, various embodiments of the present disclosure will be described in detail with reference to the accompanying drawings. Note that constituent elements denoted by the same or similar reference numerals in the drawings have the same or similar configurations or functions, and redundant description of such constituent elements will be omitted.

### First Embodiment

### <Configuration>

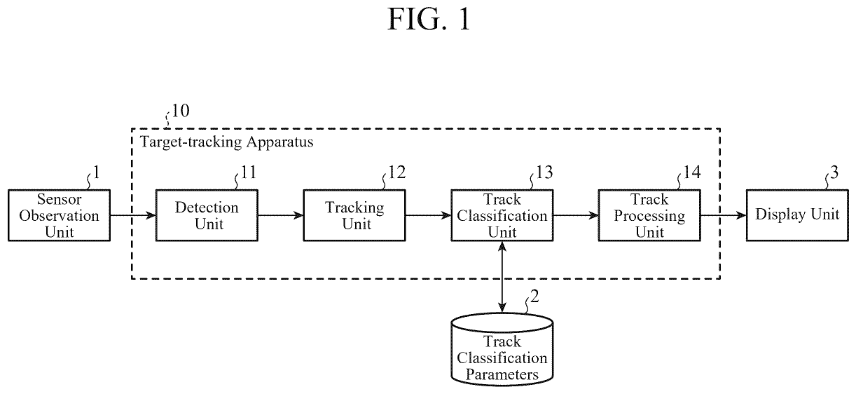

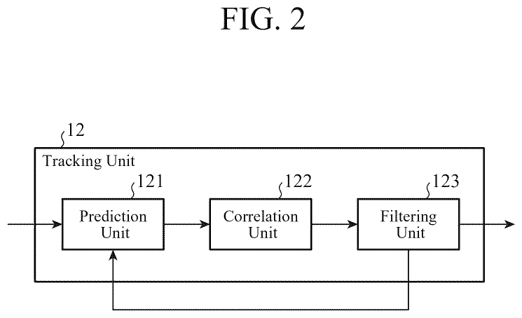

A target-tracking apparatus according to a first embodiment of the present disclosure will be described with reference to FIGS. 1 and 2. FIG. 1 is a diagram illustrating an exemplary configuration of a target-tracking apparatus 10 according to the first embodiment, and FIG. 2 is a diagram illustrating an exemplary configuration of a tracking unit 12 included in the target-tracking apparatus 10.

As illustrated in FIG. 1, one aspect of the target-tracking apparatus 10 according to the first embodiment includes a detection unit 11 that detects, from sensor data, one or more feature amounts including a position of at least one target, the tracking unit 12 that tracks the target on the basis of the detected feature amounts and outputs a track of the target being tracked, and a track classification unit 13 that determines to which of a plurality of predetermined movement patterns the output track corresponds.

In addition, another aspect of the target-tracking apparatus 10 includes the detection unit 11, the tracking unit 12, the track classification unit 13, and a track processing unit 14. The track processing unit 14 is an optional functional unit, and the target-tracking apparatus 10 does not need to include the track processing unit 14. Furthermore, as illustrated in FIG. 1, a target-tracking system using the target-tracking apparatus 10 includes a sensor observation unit 1, the target-tracking apparatus 10 connected to the sensor observation unit 1, a storage unit 2 connected to the target-tracking apparatus 10, and a display unit 3 connected to the target-tracking apparatus 10.

### (Sensor Observation Unit)

The sensor observation unit 1 is a functional unit that acquires sensor data regarding a target, obtained by sensing. The present disclosure assumes that a plurality of targets is to be sensed by the sensor observation unit 1. Meanwhile, this does not preclude a case where a single target is sensed by a product using the technique of the present disclosure.

The sensor observation unit 1 is, for example, a camera, a radar, or a laser sensor. For example, in a case where the sensor observation unit 1 is a camera, the camera acquires, as sensor data, a moving image including a plurality of frames by capturing an image of a target. The sensor observation unit 1 outputs the acquired sensor data to the detection unit 11.

### (Detection Unit)

The detection unit 11 detects a target from raw data such as an image for each frame output from the sensor observation unit 1, and outputs feature amounts of the detected target to the tracking unit 12. For example, in the case of target detection from a camera image, the detection unit 11 calculates the position and size of a target by using a target detection algorithm such as a Single Shot MultiBox Detector (SSD) or You Only Look Once (YOLO) on image data output from the sensor observation unit 1. For example, when the target is a person, the position and size of the head of the person are calculated. In addition, the detection unit 11 may calculate a target appearance feature amount, such as an RGB histogram, an HSV histogram, or a high-dimensional feature amount based on metrics-learning, for the image data output from the sensor observation unit 1. The detection unit 11 outputs target feature amounts calculated for each frame, such as a position, size, and an appearance feature amount, to the tracking unit 12.

### (Tracking Unit)

The tracking unit 12 is a functional unit including: a prediction unit 121 that predicts a feature amount to be obtained at a second time point on a basis of a first observed feature amount, the second time point being later than a first time point, the first observed feature amount being detected at the first time point; a correlation unit 122 that determines a correlation between the predicted feature amount and a second observed feature amount, the second observed feature amount being detected at the second time point; and a filtering unit 123 that performs filtering by using the second observed feature amount and the predicted feature amount having been correlated with each other and outputs time-series data of filtered feature amounts as a track of a target being tracked.

The tracking unit 12 will be described in more detail. The tracking unit 12 determines a correlation between a state of the target in a previous frame predicted at the current time and observation values of feature amounts (for example, a position, size, and an appearance feature amount) of the target in a current frame on the basis of the feature amounts output from the detection unit 11, and outputs a track of the target. Here, the track refers to time-series data including target feature amounts arranged on a time-series basis, and more specifically, refers to time-series data including filtered feature amounts arranged on a time-series basis, the filtered feature amounts having been subjected to filtering to be described below. In particular, when the target is a person, the observation value may be a bounding box with the whole body (first area) of the person regarded as a candidate area or a bounding box with the head (second area) of the person regarded as a candidate area.

More specifically, the tracking unit 12 includes the prediction unit 121, the correlation unit 122, and the filtering unit 123, as illustrated in FIG. 2.

### (Prediction Unit)

On the basis of the feature amounts output from the detection unit 11, the prediction unit 121 predicts feature amounts to be obtained at the current time (second time point; current frame) from feature amounts obtained at a past time point (first time point; previous frame). The prediction unit 121 outputs prediction results to the correlation unit 122 as predicted feature amounts.

Furthermore, the prediction unit 121 acquires observed feature amounts that are current feature amounts detected and output by the detection unit 11, and outputs the acquired observed feature amounts to the correlation unit 122.

### (Correlation Unit)

The correlation unit 122 compares the predicted feature amounts output from the prediction unit 121 with the observed feature amounts output from the prediction unit 121, determines combinations of the predicted feature amounts and the observed feature amounts, and outputs the combinations of the predicted feature amounts and the observed feature amounts to the filtering unit 123.

### (Filtering Unit)

The filtering unit 123 performs filtering by using the combinations of the predicted feature amounts and the observed feature amounts output from the correlation unit 122, and outputs filtered feature amounts to the track classification unit 13 and the prediction unit 121. Here, the filtering may be a simple method such as an aß filter, or may be a time-series filtering method based on statistical estimation, such as the Kalman filter or the particle filter.

### (Track Classification Unit)

The track classification unit 13 classifies tracks on the basis of track classification parameters and track information which is time-series data of the filtered feature amounts obtained from the tracking unit 12, counts tracks classified into each attribute by use of the track classification parameters, and outputs track information such as the classified tracks and the counted number of tracks to the track processing unit 14 or the display unit 3. The track classification parameters are stored in the storage unit 2, and the track classification unit 13 acquires the track classification parameters from the storage unit 2.

### (Track Processing Unit)

The track processing unit 14 is a functional unit that processes a track to be displayed, on the basis of the track information output from the track classification unit 13. That is, when displaying individual track information (for example, the head of a person, or the like), the track processing unit 14 may process a track so as to consider privacy or to control information. For example, the track processing unit 14 may perform processing such as the blurring or blacking out of an area based on a track obtained by tracking (for example, a substitute area based on prediction in a case where there is no detection result). Alternatively, the track processing unit 14 may perform processing such as the blurring or blacking out of a track with a specific attribute classified by the track classification unit 13.

### (Display Unit)

The display unit 3 displays statistical information of a track, individual track information, or an individual processed or unprocessed track on the basis of an output from the track classification unit 13 or the track processing unit 14.

### Operation

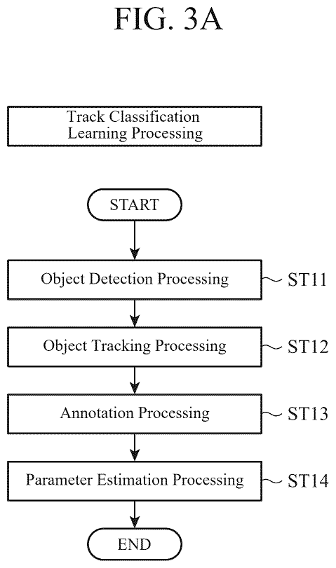

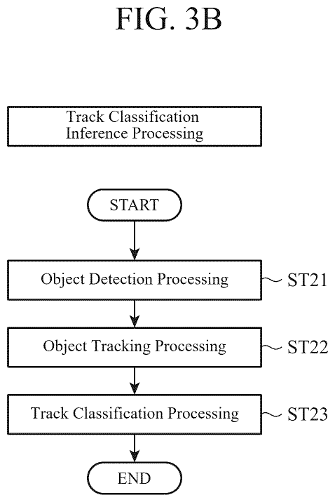

Next, operation of the target-tracking apparatus 10 will be described with reference to FIGS. 3A and 3B. FIG. 3A is a flowchart related to track classification learning processing, and FIG. 3B is a flowchart related to track classification inference processing.

### (Track Classification Learning Processing)

The track classification learning processing is processing of calculating track classification parameters on the basis of past data. In order to perform such processing, the track classification learning processing includes object detection processing (step ST11), object tracking processing (step ST12), annotation processing (step ST13), and parameter estimation processing (step ST14).

First, object detection processing is performed in step ST11. More specifically, in step ST11, the detection unit 11 detects an area of a specific portion of a target from raw data such as an image for each frame obtained from the sensor observation unit 1, and calculates feature amounts of the detected area. When the target is a person, the specific portion of the target refers to the head or whole body of the person.

Next, in step ST12 following step ST11, the tracking unit 12 performs object tracking processing. More specifically, the object tracking processing is performed as follows. The prediction unit 121 predicts current feature amounts from feature amounts obtained at a past time point output from the detection unit 11. The correlation unit 122 compares the predicted feature amounts output from the prediction unit 121 with current feature amounts, determines combinations of the predicted feature amounts and feature amounts observed at the current time, and outputs feature amounts to be filtered to the filtering unit 123. The filtering unit 123 performs filtering by using the predicted current feature amounts and the feature amounts observed at the current time, and outputs the filtered feature amounts to the track classification unit 13 and the prediction unit 121. When there are no observed feature amounts to be correlated, the predicted feature amounts are output as filtered feature amounts to the track classification unit 13. The filtered feature amounts include feature amounts such as the position and size of a target. In addition to the filtered feature amounts, the tracking unit 12 also outputs, to the track classification unit 13, error covariance calculated by the tracking unit 12, the number of times correlation has been performed, close track information, and tracking quality information such as the presence or absence of a memory track indicating a track in a case where there is no correlation. The error covariance is calculated by the filtering unit 123 by use of, for example, the Kalman filter. The number of times correlation has been performed is calculated as the number of times correlation has been performed by the correlation unit 122. The close track information is information indicating a track close to a track of a target being tracked. The close track information is obtained by the correlation unit 422 calculating a distance between tracks.

Next, in step ST13 following step ST12, annotation processing is performed. More specifically, out of tracks output from the tracking unit 12, the track classification unit 13 performs labeling of a track has a specific attribute in step ST13 on the basis of the position information of the track and data information, such as moving image information or intensity information, belonging to the track.

As classification based on the position information, it is possible to perform classification based on elements to consider regarding the way the target is present in a sensing area, such as an appearance position, a destination (disappearance position), a staying time, or the extent to which a track is adjacent to another track. Tracks may be classified in consideration of a plurality of elements to consider. A track to be classified may be classified as, for example, a track of any of a plurality of movement patterns below:
(Movement pattern 1) A track having appeared from right as viewed from a sensor
(Movement pattern 2) A track having appeared from left as viewed from the sensor
(Movement pattern 3) A track having appeared from the back and disappeared at the front as viewed from the sensor
(Movement pattern 4) A track having appeared from the front and disappeared at the back as viewed from the sensor
(Movement pattern 5) A track that moves quickly and disappears quickly despite a long distance from appearance to disappearance
(Movement pattern 6) A track of a target interested in an object in a sensing area staying in the sensing area for a long time
(Movement pattern 7) One track (group track pattern) belonging to a plurality of tracks of a plurality of targets showing similar changes. For example, a track that is a close track having a specific positional relationship with another track, such as translation, and has a velocity similar to the velocity of the another track

In addition, the labeling is performed for a specific attribute as follows: in a case where, for example, an attribute of the presence or absence of an action of closely watching an object of interest such as a posted notice or a display is determined, a track of a target that has closely watched the object of interest is labeled as a close watching track, out of track data. Alternatively, out of tracks, a track corresponding to a time period in which the target was closely watching the object of interest is extracted and labeled as a close watching track. In addition, a track that does not correspond to a close watching track is labeled as a non-close watching track. Here, at the time of labeling, a low-quality track is excluded from tracks to be classified, on the basis of the tracking quality information, or is labeled as a low-quality track, thereby performing classification.

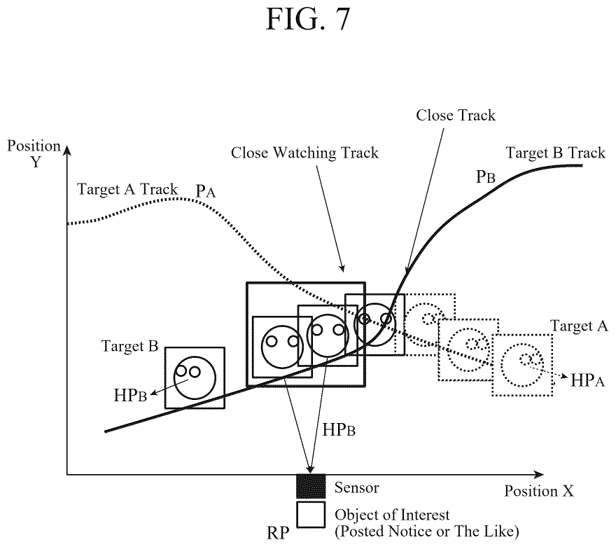

FIG. 7 illustrates tracks to be obtained when two targets are present, a sensor, and an object of interest such as a posted notice. Lines denoted by PA or PB in the drawing indicate position information of the tracks, and small square frames on the tracks indicate image data (head image) obtained at corresponding points, the image data belonging to the tracks in a detection area. A portion of a track where a target is closely watching the object of interest is referred to as a close watching track. In FIG. 7, the close watching track is indicated by a large square frame. In addition, tracks where filtered images or predicted positions of a target A and a target B are close to each other are referred to as close tracks, and in a case where the targets are close to each other, the quality of the tracks decreases. Therefore, some way to prevent a decrease in quality is devised such as not using such close tracks for close watching determination.

Next, in step ST14 following step ST13, parameter estimation processing is performed. In step ST14, the track classification unit 13 calculates parameters for performing track classification for each movement pattern on the basis of tracks and labeled data, and stores, in the storage unit 2, the calculated parameters as track classification parameters.

For example, the track classification unit 13 sets, as feature amounts of a track, a vector X in which feature amounts are arranged with respect to head image data included in the track, the feature amounts being obtained by calculation of histograms of oriented gradients (HOG) which are gradient histograms, and estimates learning parameters on the basis of the vector X and the labeled data by using a learning method such as linear discriminant analysis. In the linear discriminant analysis, the following parameters are calculated as learning parameters: a matrix W in which eigenvectors are arranged, original feature amounts being projected on the eigenvectors, a mean vector of the projected feature amounts for each class, a standard deviation, and the like. The track classification unit 13 stores, in the storage unit 2, the calculated parameters as track classification parameters, and uses the stored track classification parameters in the track classification inference processing. In this manner, the track classification unit 13 learns the track classification parameters for classifying a plurality of movement patterns, on the basis of the filtered images.

### (Track Classification Inference Processing)

The track classification inference processing is processing of classifying tracks by using the track classification parameters obtained by the track classification learning processing. In order to perform such processing, the track classification inference processing includes object detection processing (step ST21), object tracking processing (step ST22), and track classification processing (step ST23). The object detection processing (step ST21) and the object tracking processing (step ST22) are the same as the object detection processing (step ST11) and the object tracking processing (step ST12) in the track classification learning processing, respectively, and thus redundant description will be omitted.

In step ST23, the track classification processing is performed. The track classification processing is performed by the track classification unit 13. First, a track obtained from the tracking unit 12 is classified on the basis of position information of the track. In the track classification processing, a movement pattern having a most similar track is selected from among movement patterns classified in the track classification learning processing, for a track output from the tracking unit 12 at a timing when a track disappears while a state in which there is no detection result correlated with a predicted track is continuing in the tracking unit 12 or at a timing when a track having a specific length is generated. A movement pattern may be selected on the basis of, for example, the degree of similarity between tracks or the closeness of the start points or end points (vanishing points) of the tracks to each other. In addition, it is determined whether in a target track a specific action (close watching) has been performed by use of track classification parameters for each selected movement pattern. Specifically, first, feature amounts are calculated which are obtained by calculation of HOG for image data belonging to the track and which are arranged on a time-series basis. Next, a statistical distance is calculated from projected feature amounts and the mean vector and standard deviation of each class, the projected feature amounts being projected by a projection matrix in which eigenvectors serving as track classification parameters are arranged with respect to the calculated feature amounts. Then, a class having a smallest statistical distance is selected, and an action represented by the selected class is output to the display unit 3. For example, when it is determined whether a person has performed close watching as a specific action, the number of tracks belonging to a close watching class may be counted and displayed, on the display unit 3, as the number of persons who have performed close watching. Alternatively, a track regarding which close watching determination has been made may be highlighted, and be displayed simultaneously with video data. Note that the track classification processing may be performed at a timing when a stable track disappears.

A track may be processed by the track processing unit 14 in a step (not illustrated) following step ST23.

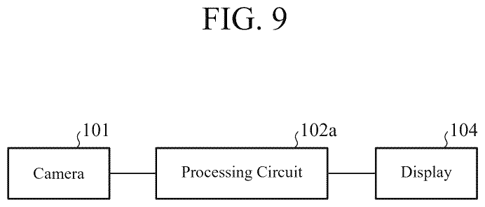

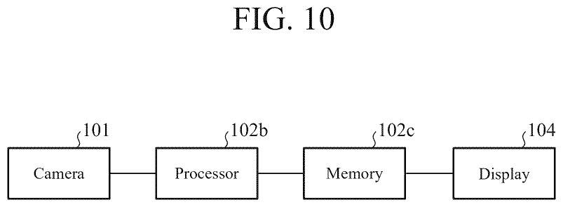

Next, exemplary hardware configurations of the target-tracking apparatus 10 and the target-tracking system including the target-tracking apparatus 10 will be described with reference to FIGS. 9 and 10. Various functions of the target-tracking apparatus 10 are implemented by processing circuitry. The processing circuitry may be a dedicated processing circuit 102a as illustrated in FIG. 9, or may be a processor 102b that executes a program stored in a memory 102c as illustrated in FIG. 10. Furthermore, the sensor observation unit 1 and the display unit 3 included in the target-tracking system are implemented by, for example, a camera 101 and a display 104, respectively.

In a case where the processing circuitry is the dedicated processing circuit 102a, the dedicated processing circuit 102a corresponds to, for example, a single circuit, a composite circuit, a programmed processor, a parallel programmed processor, an application specific integrated circuit (ASIC), a field-programmable gate array (FPGA), or a combination thereof. The various functions of the target-tracking apparatus 10 may be separately implemented by a plurality of processing circuits, or may be collectively implemented by a single processing circuit. In addition, a memory (not illustrated) is connected to the processing circuit 102a to implement the storage unit 2.

When the processing circuitry is the processor 102b, the various functions of the target-tracking apparatus 10 are implemented by software, firmware, or a combination of software and firmware. The software and the firmware are each described as a program and stored in the memory 102c. The processor 102b reads and executes the program stored in the memory 102c to implement the function of each functional unit of the target-tracking apparatus 10. Here, examples of the memory 102c include a nonvolatile or volatile semiconductor memory such as a random access memory (RAM), a read-only memory (ROM), a flash memory, an erasable programmable read-only memory (EPROM), or an electrically erasable programmable read-only memory (EEPROM), a magnetic disk, a flexible disk, an optical disk, a compact disk, a mini disk, and a DVD.

Note that some of the various functions of the target-tracking apparatus 10 may be implemented by dedicated hardware, and some may be implemented by software or firmware. In this manner, the processing circuitry can implement each of the above-described functions by hardware, software, firmware, or a combination thereof.

According to the target-tracking apparatus 10, it is possible to grasp a detailed behavior of a track with high accuracy by analyzing moving image information for each of movement patterns of tracks to ease the effect of a difference in the purpose or way of close watching between the movement patterns. In addition, it is possible to separately classify data of a scene at which it is difficult to distinguish between targets, by using image information based on filtered feature amounts output from the tracking unit 12 and by performing labeling based on tracking quality. As a result, the accuracy of motion estimation can be expected to increase.

### Second Embodiment

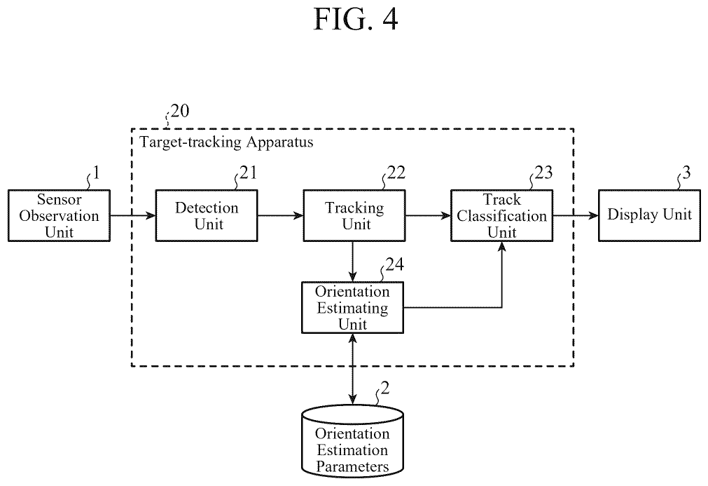

A target-tracking apparatus according to a second embodiment of the present disclosure will be described with reference to FIG. 4. FIG. 4 is a diagram illustrating an exemplary configuration of a target-tracking apparatus 20 according to the second embodiment. As illustrated in FIG. 4, the target-tracking apparatus 20 includes a detection unit 21 and a tracking unit 12 as with the target-tracking apparatus 10 according to the first embodiment. The target-tracking apparatus 20 includes an orientation estimating unit 24 as an additional functional unit, and also includes a track classification unit 23. In response to the addition of the orientation estimating unit 24, the function of the track classification unit 13 has been modified to obtain the track classification unit 23. Furthermore, as in the case of the first embodiment, the target-tracking apparatus 20 may include a track processing unit (not illustrated). In addition, as illustrated in FIG. 4, a target-tracking system using the target-tracking apparatus 20 includes a sensor observation unit 1, the target-tracking apparatus 20 connected to the sensor observation unit 1, a storage unit 2 connected to the target-tracking apparatus 20, and a display unit 3 connected to the target-tracking apparatus 20.

### (Orientation Estimating Unit)

The orientation estimating unit 24 estimates orientation estimation parameters, which are parameters for estimating an orientation such as an azimuth or elevation, from past tracks stored in the storage unit 2, that is, time-series data of filtered images, positions, and track quality. The orientation estimating unit 24 estimates orientations of an object by using the estimated orientation estimation parameters for a currently obtained track.

The orientation estimating unit 24 subdivides the orientations of the object, and annotates a corrected image output from the tracking unit 12 for each orientation of the object, that is, an image based on filtered feature amounts. For example, azimuths and elevations of an object are subdivided, and annotation is performed on a corrected image for each of specific values of the azimuths and the elevations. In addition, the orientation estimating unit 24 learns orientation estimation parameters, and outputs, to the track classification unit 23, a result of estimating orientations with respect to the currently obtained track.

The track classification unit 23 determines whether a target has closely watched an object of interest on the basis of information of the orientation estimated by the orientation estimating unit 24, and the position of the track, that is, on the basis of an angle formed by a position of the object of interest relative to the track and the orientation estimated in the orientation estimation. Close watching determination is performed by use of, for example, the N in M determination method and by determination as to whether an angle indicating that the object of interest is visually recognized has been formed N times out of M in the past. At the time of the close watching determination, an image with degraded quality, such as an image having a high possibility of degradation of a detection result due to the presence of a close track, may be excluded from images to be subjected to N in M determination, on the basis of track quality.

Furthermore, track classification may be performed by use of a likelihood ratio L in accordance with formula (1) below. That is, the track classification unit 23 may calculate a likelihood ratio from the position of the track of the target being tracked and the orientation of the target, and estimates a probability that the target has closely watched the object of interest from the magnitude of the calculated likelihood ratio, the likelihood ratio being a ratio between a probability that the track of the target being tracked is a close watching track and a probability that the track of the target being tracked is a normal track, the normal track being a track that is not the close watching track. In formula (1), H1 denotes a specific action hypothesis, such as close watching or a suspicious or anomalous behavior, and H0 denotes a normal track. In addition, p(HP,P,RP|H1) denotes a probability that the track is a close watching track on which the target has performed a specific action such as close watching, and p(HP,P|H0) denotes a probability that the track is a normal track. Furthermore, HP denotes a vector in which orientations (azimuths) estimated from a single snapshot image are arranged on a time-series basis, P denotes a vector in which the centers or foot positions of a target are arranged on a time-series basis, and RP denotes a position vector of an object of interest such as a posted notice.

$$L = p ( H P , P , R P \vert H 1 ) / p ( H P , P \vert H 0 ) \qquad ( 1 )$$

Here, p(HP,P,RP|H1) denotes a probability distribution of an exponential family such as a normal distribution in which the probability is high in a case where the degree of coincidence of the orientation HP estimated from an image with the direction of the position vector with respect to the object of interest calculated from a difference between P and RP is high and the difference between P and RP is equal to or less than a certain distance in the field of view, and p(HP,P|H0) denotes a probability distribution of an exponential family such as a normal distribution in which the probability is high on the assumption that a normal action is being performed in which motion matches an orientation in a case where the direction of a velocity vector that is a time difference of P matches the orientation HP calculated from the image.

It is possible to extract a track having a high probability of having performed the specific action and a low probability of having performed a normal action, by outputting a track (L>Th) with a likelihood ratio exceeding a threshold Th as a specific track. Here, the threshold Th may be determined by use of a likelihood ratio test or the like, or may be adjusted by use of existing correct answer data in such a way that the false recognition rate is kept constant.

In the case of determining whether a track is not normal in a state where there is no object of interest such as a specific posted notice, an inverse L2 of p(HP,P|H0) that is a probability that the track is a normal track may be calculated as in formula (2) below instead of the likelihood ratio, and an anomalous track may be classified by threshold determination processing (L2>Th2).

$$L 2 = 1 / p ( H P , P \vert H 0 ) \qquad ( 2 )$$

It is possible to extract a person for whom a face direction of the track does not match the direction of the position vector of the track by performing threshold determination by use of L2.

As is clear from the above, according to the second embodiment, it is possible to estimate a detailed behavior of a track by performing classification of the track from orientation information obtained by image processing, the position information of the track, and the position vector of the object of interest.

### Third Embodiment

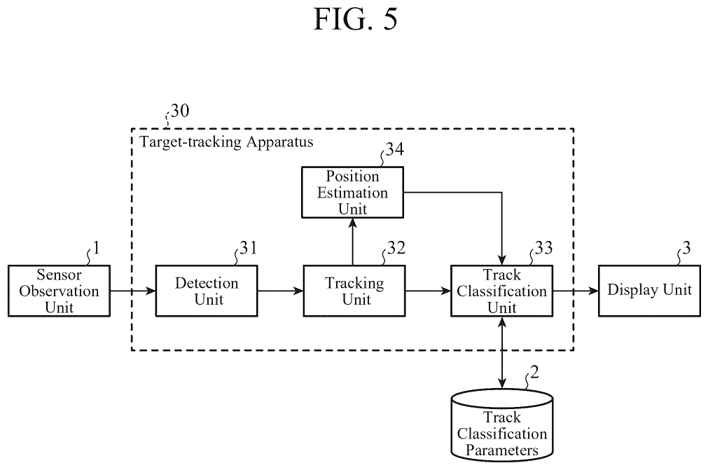

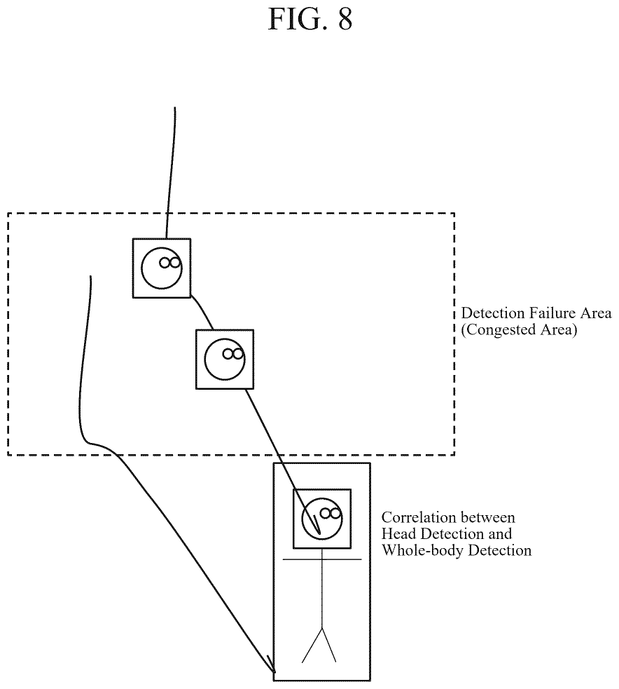

A target-tracking apparatus according to a third embodiment of the present disclosure will be described with reference to FIGS. 5 and 8. FIG. 5 is a diagram illustrating an exemplary configuration of a target-tracking apparatus 30 according to the third embodiment, and FIG. 8 is a diagram for describing operation of the target-tracking apparatus 30. As illustrated in FIG. 5, the target-tracking apparatus 30 includes a detection unit 31, a tracking unit 32, and a track classification unit 13, as with the target-tracking apparatus 10 according to the first embodiment. In addition, the target-tracking apparatus 30 includes a position estimating unit 34 as a new functional unit. As the position estimating unit 34 is newly provided, the detection unit 11, the tracking unit 12, and the track classification unit 13 of the target-tracking apparatus 10 have been improved to obtain the detection unit 31, the tracking unit 32, and the track classification unit 33 of the target-tracking apparatus 30, respectively. Furthermore, as in the case of the first embodiment, the target-tracking apparatus 30 may include a track processing unit (not illustrated). Improved points will be described below.

The case where the detection unit 11 detects the head of a person has been described in the first embodiment. Meanwhile, the detection unit 31 detects not only the head of a person but also the whole body of the person in the third embodiment. More generally speaking, the detection unit 31 detects a first area (whole body) and a second area (head) of a target. The second area is narrower than the first area. In addition to feature amounts of the head of the person, the detection unit 31 also outputs feature amounts of the whole body of the person to the tracking unit 32.

The tracking unit 32 outputs a track in the first area and a track in the second area as tracks of the target being tracked. That is, the tracking unit 32 tracks the head and the whole body, and outputs the tracks to the position estimating unit 34.

The position estimating unit 34 estimates the position of the track in the first area and the position of the track in the second area, determines the correspondence relationship between the track in the first area and the track in the second area, and calculates a second position of the target. Hereinafter, a specific description will be given.

The position estimating unit 34 correlates the head track with the whole-body track on the basis of a relationship between relative positions and size, and calculates a distance from the head on the basis of internal and external parameters of a camera and a foot position of the correlated whole-body track. As a result, the distance from the head is accurately calculated on the basis of the foot position. As an example of the correlation between a head track and a whole-body track, a correspondence relationship (correlation) between a track of head detection and a track of whole-body detection is determined from a head detection position relative to a whole-body detection position as illustrated in FIG. 8. Here, in consideration of a detection failure area in which only head detection is effective under a congested environment or the like, the size of the whole body of the target may be estimated on the basis of track information corresponding to the time when head detection and whole-body detection have simultaneously appeared, and may be used for distance calculation. The position estimating unit 34 outputs the calculated position of the head track to the track classification unit 33.

The track classification unit 33 classifies the track on the basis of accurate position information of the head calculated above.

As is clear from the above, according to the third embodiment, it is possible to obtain accurate position information of a head track, and thus, it is possible to accurately classify a track on the basis of the accurate position information.

### Fourth Embodiment

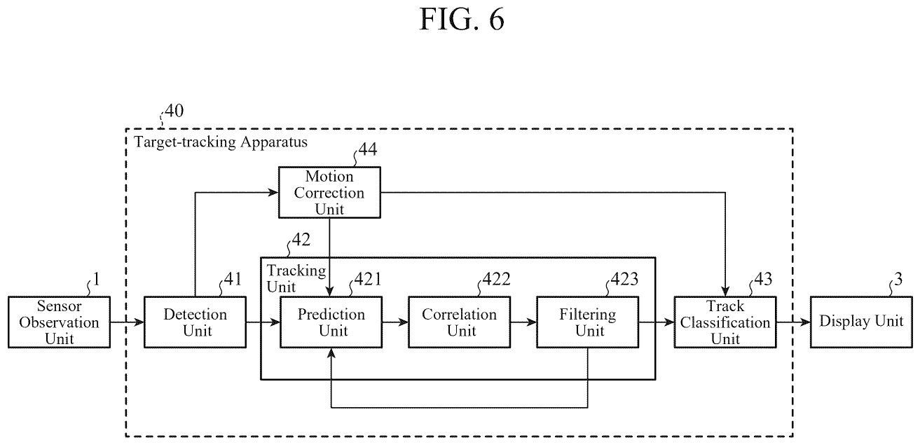

A target-tracking apparatus according to a fourth embodiment of the present disclosure will be described with reference to FIG. 6. FIG. 6 is a diagram illustrating an exemplary configuration of a target-tracking apparatus 40 according to the fourth embodiment. As illustrated in FIG. 6, the target-tracking apparatus 40 includes a detection unit 41, a tracking unit 42, and a track classification unit 43, as with the target-tracking apparatus 10 according to the first embodiment. Furthermore, the target-tracking apparatus 40 includes a motion correction unit 44 as a new functional unit. Furthermore, as in the case of the first embodiment, the target-tracking apparatus 40 may include a track processing unit (not illustrated).

The motion correction unit 44 is a functional unit that outputs motion information for correcting a gap between a first image and a second image due to a difference between a first position where the first image has been acquired and a second position where the second image has been acquired, the first image being acquired at a first time point, the second image being acquired at a second time point immediately after the first time point. That is, the motion correction unit 44 corrects a gap between the first image and the second image in a case where the sensor observation unit 1 acquires the first image and the second image at different positions.

In order to estimate entire image motion, the motion correction unit 44 applies a feature point extraction method, such as Oriented FAST and Rotated BRIEF (ORB) or Accelerated KAZE (AKAZE), and a feature point matching method to two images obtained from consecutive preceding and subsequent frames, and then estimates a mean vector of entire image movement between frames, an affine transformation matrix of the images, or a homography transformation matrix of the images from an obtained feature point matching result. The motion correction unit 44 outputs an estimation result as image motion information to the tracking unit 42 and the track classification unit 43. Here, at the time of correction of the entire image motion, the feature point extraction method may be applied to the outside of a candidate area of detection by the detection unit 41 so as not to include a velocity component deriving from an individual mobile object. In addition, the amount of movement on two-dimensional bird's-eye view coordinates may be calculated from the image motion information by use of internal parameters and external parameters of a camera.

The tracking unit 42 corrects a prediction vector and tracks a target by converting a movement prediction vector of an individual target by use of the image motion information input from the motion correction unit 44. For example, the mean vector of entire image movement is subtracted from the movement prediction vector of the individual target. It is possible to accurately predict the position of the individual target by performing correction in this manner.

The track classification unit 43 corrects position information of a track and makes a determination by using the image motion information input from the motion correction unit 44.

Here, the motion correction unit 44 may estimate the image motion information or the amount of movement of a sensor by using self-position estimation information obtained by an internal sensor such as an inertial navigation system (INS) sensor.

As is clear from the above, according to the fourth embodiment, it is possible to accurately perform target tracking and track classification by correcting sensing data in consideration of movement of the sensor observation unit 1 on the assumption that a platform (not illustrated) on which the sensor observation unit 1 is mounted moves.

Note that the embodiments can be combined, or can each be modified or omitted as needed.

### INDUSTRIAL APPLICABILITY

The target-tracking apparatus of the present disclosure can be used as an apparatus that separately tracks targets for various purposes such as preventive maintenance or guided advertising under an environment where a plurality of targets is present.

### REFERENCE SIGNS LIST

1: sensor observation unit, 2: storage unit, 3: display unit, 10: target-tracking apparatus, 11: detection unit, 12: tracking unit, 13: track classification unit, 14: track processing unit, 20: target-tracking apparatus, 21: detection unit, 23: track classification unit, 24: orientation estimating unit, 30: target-tracking apparatus, 31: detection unit, 32: tracking unit, 33: track classification unit, 34: position estimating unit, 40: target-tracking apparatus, 41: detection unit, 42: tracking unit, 43: track classification unit, 44: motion correction unit, 101: camera, 102a: processing circuit, 102b: processor, 102c: memory, 104: display, 121: prediction unit, 122: correlation unit, 123: filtering unit

1. A target-tracking apparatus comprising:
detection circuitry to detect a feature amount from sensor data, the feature amount including a position of at least one target;
tracking circuitry to track the target on a basis of the detected feature amount and output a track of the target being tracked, the track including position information and data information of the track; and
track classification circuitry to classify the output track as any one of a plurality of predetermined movement patterns, by using track classification parameters obtained by track classification learning processing on a basis of past data, on a basis of a plurality of elements to consider regarding a way the target is present in a sensing area, indicated by the position information and data information of the track, the elements to consider including at least one of: a position, a velocity, a relationship with another track, or an orientation of the target, and output track information of the classified track.

2. The target-tracking apparatus according to claim 1, wherein the data information includes at least moving image information or intensity information.

3. The target-tracking apparatus according to claim 1, wherein the position in the plurality of elements to consider includes an appearance position and a disappearance position in the sensing area.

4. The target-tracking apparatus according to claim 1, wherein
the tracking circuitry includes:
prediction circuitry to predict a feature amount to be obtained at a second time point on a basis of a first observed feature amount, the second time point being later than a first time point, the first observed feature amount being detected at the first time point;
correlation circuitry to determine a correlation between the predicted feature amount and a second observed feature amount, the second observed feature amount being detected at the second time point; and
filtering circuitry to perform filtering by using the second observed feature amount and the predicted feature amount having been correlated with each other and output time-series data of filtered feature amounts as the track.

5. The target-tracking apparatus according to claim 4, wherein
the sensor data include images, and
the track classification circuitry learns track classification parameters on a basis of filtered images, the track classification parameters being for classifying the plurality of predetermined movement patterns.

6. The target-tracking apparatus according to claim 1, wherein
the track classification circuitry determines to which of the plurality of predetermined movement patterns the output track corresponds, by using tracking quality information indicating track quality.

7. The target-tracking apparatus according to claim 1, further comprising:
track processing circuitry to process information to be displayed, on a basis of the output track information.

8. The target-tracking apparatus according to claim 5, further comprising:
orientation estimating circuitry to estimate an orientation of the target, the orientation being estimated from each of the images.

9. The target-tracking apparatus according to claim 8, wherein
the track classification circuitry infers whether the target is closely watching an object of interest, on a basis of a degree of coincidence of a position of the target with the estimated orientation of the target, the position of the target being a position with respect to a position of the object of interest.

10. The target-tracking apparatus according to claim 9, wherein
the track classification circuitry calculates a likelihood ratio from a position of the track and the estimated orientation of the target, and estimates a probability that the target has closely watched the object of interest from magnitude of the calculated likelihood ratio, the likelihood ratio being a ratio between a probability that the track is a close watching track and a probability that the track is a normal track, the normal track being a track that is not the close watching track.

11. The target-tracking apparatus according to claim 8, wherein
the track classification circuitry infers whether the target is behaving suspiciously or anomalously from a degree of coincidence of a direction of a velocity vector with the estimated orientation of the target, the velocity vector representing a temporal change in position of the target.

12. The target-tracking apparatus according to claim 1, wherein
the track classification circuitry performs the classification when the track disappears.

13. The target-tracking apparatus according to claim 1, wherein
the detection circuitry detects a first area and a second area of the target, the second area being narrower than the first area,
the tracking circuitry outputs a track in the first area and a track in the second area as the track, and
the target-tracking apparatus further comprises position estimating circuitry to calculate a second position of the target by estimating a position of the track in the first area and a position of the track in the second area and determining a correspondence relationship between the track in the first area and the track in the second area.

14. The target-tracking apparatus according to claim 1, wherein
the at least one target includes a plurality of targets,
the plurality of predetermined movement patterns includes a group track pattern corresponding to similar changes indicated by a plurality of tracks, and
the track classification circuitry determines that a track of any one of the plurality of targets corresponds to the group track pattern.

15. The target-tracking apparatus according to claim 1, wherein
the sensor data include a plurality of temporally continuous images,
the target-tracking apparatus further comprises motion correction circuitry to output motion information for correcting a gap between a first image and a second image due to a difference between a first position where the first image has been acquired and a second position where the second image has been acquired, the first image being acquired at a first time point, the second image being acquired at a second time point immediately after the first time point, and
the tracking circuitry estimates a position of an individual target excluding motion of a sensor or entire image motion, and tracks the target, by using the output motion information.

16. The target-tracking apparatus according to claim 1, wherein
the sensor data include a plurality of temporally continuous images,
the target-tracking apparatus further comprises motion correction circuitry to output motion information for correcting a gap between a first image and a second image due to a difference between a first position where the first image has been acquired and a second position where the second image has been acquired, the first image being acquired at a first time point, the second image being acquired at a second time point immediately after the first time point, and
the track classification circuitry corrects the position information included in the output track to position information of an individual track excluding motion of a sensor or entire image motion, and performs the classification, by using the output motion information.

17. A target-tracking apparatus comprising:
detection circuitry to detect a feature amount from sensor data, the feature amount including a position of at least one target;
tracking circuitry to track the target on a basis of the detected feature amount and output a track of the target being tracked; and
track classification circuitry to classify the output track as any one of a plurality of predetermined movement patterns, by using track classification parameters obtained by track classification learning processing on a basis of past data, and output track information of the classified track,
wherein the sensor data is an image, and
the track classification circuitry learns a plurality of track classification parameters for classifying the plurality of predetermined movement patterns on a basis of filtered images.

18. A target-tracking apparatus comprising:
detection circuitry to detect a feature amount from sensor data, the feature amount including a position of at least one target;
tracking circuitry to track the target on a basis of the detected feature amount and output a track of the target being tracked; and
track classification circuitry to classify the output track as any one of a plurality of predetermined movement patterns, by using track classification parameters obtained by track classification learning processing on a basis of past data, and output track information of the classified track,
wherein the detection circuitry detects a first area and a second area of the target, the second area being narrower than the first area, the tracking circuitry outputs a track in the first area and a track in the second area as the track, and
the target-tracking apparatus further comprises position estimating circuitry to calculate a second position of the target by estimating a position of the track in the first area and a position of the track in the second area and determining a correspondence relationship between the track in the first area and the track in the second area.

19. A target-tracking method comprising:
detecting a feature amount from sensor data, the feature amount including a position of at least one target;
tracking the target on a basis of the detected feature amount and output a track of the target being tracked, the track including position information and data information of the track; and
classifying the output track as any one of a plurality of predetermined movement patterns, by using track classification parameters obtained by track classification learning processing on a basis of past data, on a basis of a plurality of elements to consider regarding a way the target is present in a sensing area, indicated by the position information and data information of the track, the elements to consider including at least one of: a position, a velocity, a relationship with another track, or an orientation of the target.
